(19) United States
(12) Patent Application Publication
(10) Pub. No.: US 2010/0169572 A1
(43) Pub. Date: Jul. 1, 2010

(54) DATA STORAGE METHOD, APPARATUS AND SYSTEM FOR INTERRUPTED WRITE RECOVERY

(75) Inventors: Derek John Bendixen, Thornton, CO (US); Gregory Allan Yarnell, Wichita, KS (US)

Correspondence Address: SMITH FROHWEIN TEMPEL GREENLEE BLAHA LLC, TWO RAVINIA DRIVE, SUITE 700, ATLANTA, GA, 30346, US

(73) Assignee: LSI CORPORATION, Milpitas, CA (US)

(21) Appl. No.: 12/438,019

(22) PCT Filed: Jul. 22, 2008
(86) PCT No.: PCT/US08/70719

§ 371 Date: Feb. 19, 2009

(51) Int. Cl. G06F 12/00; G06F 12/02; G06F 12/16; G06F 13/24

(52) U.S. Cl. 711/114; 711/165; 710/260; 711/E12.001

(57) ABSTRACT

Embodiments of the invention include a method, apparatus and system for storing data that involves storing boundary information for data that is being written to a plurality of data storage devices. The method includes storing boundary information for a write operation of data to a plurality of data storage device, writing the data to the plurality of data storage devices and removing the recorded boundary information upon completion of the write operation of the data to the plurality of data storage devices. The boundary information can indicate the data storage device regions where particular sets of data are to be written during the write operation. If an interruption occurs during the write operation, the boundary information can be used to recover from the interruption by identifying the specific data storage device region or regions where data was being written when the interruption occurred.

### BACKGROUND OF THE INVENTION

1. Field of the Invention

The invention relates to redundant data storage methods and systems. More particularly, the invention relates to write interruption recovery for redundant electronic data storage methods, devices and systems.

2. Description of the Related Art

One type of electronic data storage system uses a variety of disk drives arranged in a redundant array of independent disks (RAID) format, with data mirrored across the plurality of disks. In such arrangement, if one data storage disk becomes unavailable, data can be accessed from one of the other disks. Such data storage systems often are referred to as n-way mirror systems.

In many n-way mirror systems, write interruptions, such as by a loss of system power, can leave the data storage system in a state where new data was written to only a subset of the data storage devices. If such condition is not detected and corrected, the integrity of the n-way mirror system is compromised, because every data storage device no longer is guaranteed to contain the same data stored therein.

Conventional methods exist for detecting and recovering from write interruptions in an n-way mirrored set of data storage devices. However, conventional methods can be relatively inefficient in correcting a write interruption once the write interruption has been detected. For example, typically, no information is stored to indicate what region on each storage device was being changed during a write operation. To recover from an interruption, conventional methods often perform a complete copy of all data from one device to all of the other devices. Alternatively, conventional methods perform an exhaustive comparison of all data on all devices to determine the differences, which then must be corrected. Both processes are relatively inefficient. Moreover, the inefficiency of these conventional processes increases linearly as the size of the devices or the number of devices increases.

Accordingly, there is a need for improved methods for correcting a detected write interruption in redundant data storage systems, such as n-way mirror systems.

### SUMMARY OF THE INVENTION

The invention is embodied in a data storage method, apparatus and system that involves storing or recording boundary information for data that is being written to a plurality of data storage devices. The method includes storing boundary information for a write operation of data to a plurality of data storage device, writing the data to the plurality of data storage devices and removing the recorded boundary information upon completion of the write operation of the data to the plurality of data storage devices. The boundary information can indicate the data storage device regions where particular sets of data are being written during the write operation. If an interruption occurs during the write operation of the data to one or more data storage devices, the boundary information can be used to recover from the interruption by identifying the specific data storage device region or regions where data was being written when the interruption occurred. Therefore, unlike conventional data storage systems, only the particular regions where data was being written when the interruption occurred need to be rewritten.

### BRIEF DESCRIPTION OF THE DRAWINGS

FIG. 1 is a block diagram of a conventional redundant data storage system including a plurality of data storage devices coupled to a host system including an application suitable for using the data storage device;

FIG. 2 is a block diagram of a data storage system according to embodiments of the invention;

FIG. 3 is a block diagram of a method for writing to the data storage system of FIG. 2 according to embodiments of the invention; and

FIG. 4 is a block diagram of the detection and recovery step of FIG. 2 according to embodiments of the invention.

### DETAILED DESCRIPTION OF EXEMPLARY EMBODIMENTS

In the following description, like reference numerals indicate like components to enhance the understanding of the invention through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the invention.

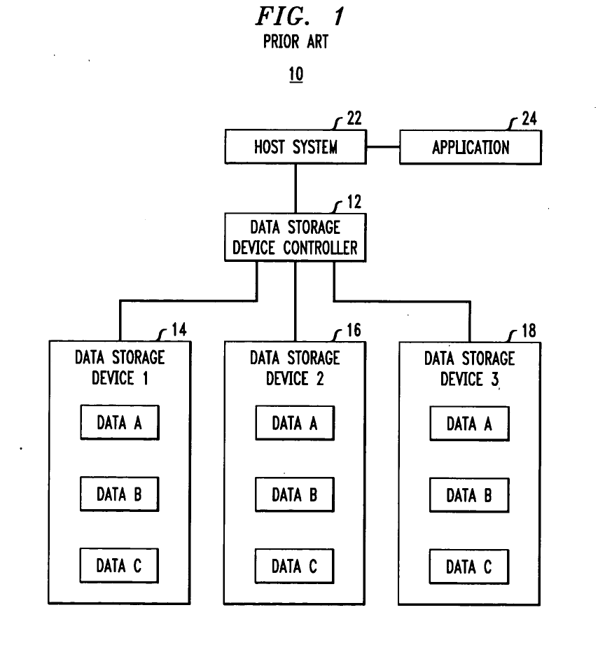

Referring now to FIG. 1, shown is a block diagram of a conventional redundant data storage system 10 coupled to a host system including an application suitable for using the data storage device system 10. The data storage system 10 can include a data storage device controller 12 coupled to a number of data storage devices, such as a first data storage device 14, a second data storage device 16 and a third data storage device 18. Each of the data storage devices can be a data storage disk or drive, or other suitable data storage device.

The data storage device controller 12 also is coupled to a host system 22, which is coupled to an application 24 that produces data to be stored. The data storage device controller 12 receives data from the application 24 via the host system 22 and stores the received data to each of the data storage devices 14, 16, 18, thereby establishing redundancy. For example, if the application 24 generates three sets of data to be stored (e.g., data set A, data set B, data set C), the data storage device controller 12 will write each data set to each of the data storage devices 14, 16, 18. In this manner, the data storage system 10 provides data storage integrity and access should one of the data storage devices become unavailable, such as due to a drive malfunction, data corruption or other condition of unavailability. In such case, data can be accessed from one of the other data storage devices.

However, even in such redundant data storage systems, when writing data to the data storage devices, a write operation interruption, error condition, loss of power, or the addition or removal of an accessible data storage device can occur, thus calling into question the validity of the data that was just written or was currently being written to the data storage devices. For example, by encountering an interruption during a write operation to the storage devices, one or more of the data storage device controller 12, the host system 22 and the application 24 will want to determine which data set or sets are valid, i.e., which data sets were properly written to and stored across all of the data storage devices. Furthermore, if it has been determined that the interruption has compromised the integrity of the data written to one or more data storage devices, the data storage device controller 12 or other appropriate component will want to begin the process of correcting, recovering or otherwise restoring the integrity of the affected data across all of the data storage devices affected by the interruption.

As discussed hereinabove, conventionally, during the data write operation to the data storage devices, no information is written or otherwise stored on the data storage devices, within the data storage controller or anywhere else, that indicates the particular region or location of the data storage devices to which the data currently is being written or was just written. During conventional processes to recover from a data write interruption, the data storage device controller 12 or other appropriate component within the system 10 usually determines if one of the data storage devices (e.g., the first data storage device 14) has stored therein all of the data (e.g., data sets A, B and C) that was supposed to have been written to all of the data storage devices. Then, a complete copy of all the data sets from that particular data storage device is written to all of the other data storage devices. For example, a complete copy of the data sets A, B and C successfully stored on the first data storage device 14 will be copied to the other data storage devices, e.g., the second data storage device 16 and the third data storage device 18. As discussed previously herein, such process is relatively inefficient.

Alternatively, the data storage device controller 12 or other appropriate component within the data storage system 10 can attempt to copy only those data sets or portions of data sets that differ across the data storage devices. However, such process involves the relatively arduous process of performing an exhaustive comparison of all data sets written to all data storage devices. Upon completion of such comparison, the individual data sets or portions of data sets then can be copied from the source data storage device having data integrity to the one or more target data storage devices whose data integrity may have been compromised. However, this alternative process likely will be just as inefficient and time consuming, if not more so, as performing a complete copy of all the data sets from a source data storage device having data integrity to all of the target data storage devices that may not have complete data integrity.

Embodiments of the invention provide an improvement to conventional methods for detecting and recovering from a write operation interruption to a redundant data storage system, such as an n-way mirror data storage system. Embodiments of the invention involve storing boundary information for a write operation, i.e., the boundaries of the write operation. For example, the boundary information can indicate which region of each data storage device is to be written to by the current data write operation. In the event of a write operation interruption, the boundary information can be used to recover from the interrupted write operation. The boundary information can be stored on or written to a location within one of more of the data storage devices and/or to a location external to the data storage devices, such as within a data storage apparatus and/or its controller.

In using the boundary information, the recovery process from an interrupted write operation is more efficient than in conventional methods, e.g., by decreasing the time required to correct the write interruption. By recording or storing the boundaries of each write operation, only the region of the data storage device being written to during the write interruption, i.e., the critical region, needs to be considered for recovery or correction. Areas of the data storage device outside of or other than the critical region do not need to be changed or rewritten, and therefore remain the same on every data storage device. Thus, no recovery time needs to be spent on copying non-critical regions of the data storage devices or determining what regions are different among the plurality of data storage devices. Only the critical region needs to be copied during the recovery process. In this manner, the performance of the data storage system in recovering from an interrupted write operation is significantly improved at least in terms of recovery time over conventional recovery processes.

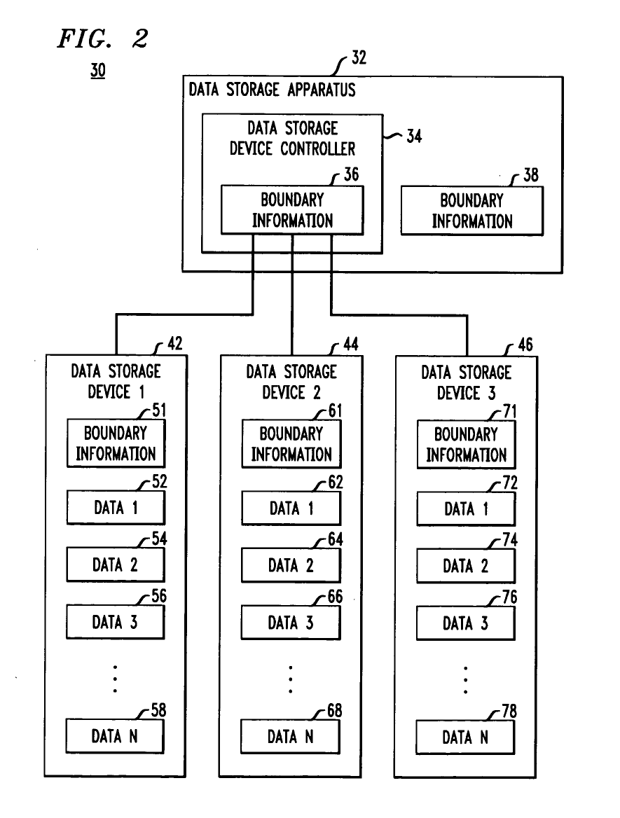

Referring now to FIG. 2, shown is a block diagram of a redundant data storage system 30 according to embodiments of the invention. The data storage system 30 is a redundant data storage system, such as an n-way mirror system or other suitable redundant data storage system. The data storage system 30 includes a data storage apparatus 32, which includes a data storage device controller 34. Also, as will be discussed in greater detail hereinbelow, the data storage device controller 34 can include a boundary information location 36 for the storage of boundary information. Also, instead of or in addition to the boundary information location 36 within the data storage device controller 34, the data storage system 30 can include a boundary information location 38 that is external to the data storage device controller 34, e.g., within the data storage apparatus 32.

The data storage apparatus 32, via the data storage device controller 34, can be coupled to a plurality of data storage devices, such as a first data storage device 42, a second data storage device 44 and a third data storage device 46. Each of the data storage devices can be a data storage disk or drive, or any other suitable data storage device. The data storage apparatus 32 is configured to be coupled to a host system (not shown), which typically also is coupled to an application (not shown) that generates data to be stored within the data storage system 30.

The data storage apparatus 32 and/or the data storage device controller 34 can be comprised partially or completely of any suitable structure or arrangement, e.g., one or more integrated circuits. Also, it should be understood that the data storage apparatus 32 includes other components, hardware and software (not shown) that are used for the operation of other features and functions of the data storage apparatus 32 and/or the data storage device controller 34 not specifically described herein. All relevant portions of the data storage apparatus 32 and/or the data storage device controller 34 can be partially or completely configured in the form of hardware circuitry and/or other hardware components within a larger device or group of components. Alternatively, all relevant portions of the data storage apparatus 32 and/or the data storage device controller 34 can be partially or completely configured in the form of software, e.g., as processing instructions and/or one or more sets of logic or computer code. In such configuration, the logic or processing instructions typically are stored in a memory element. The memory element typically is coupled to a processor or controller, e.g., the data storage device controller 34. The controller accesses the necessary instructions from the memory element and executes the instructions or transfers the instructions to the appropriate location within the data storage apparatus 32.

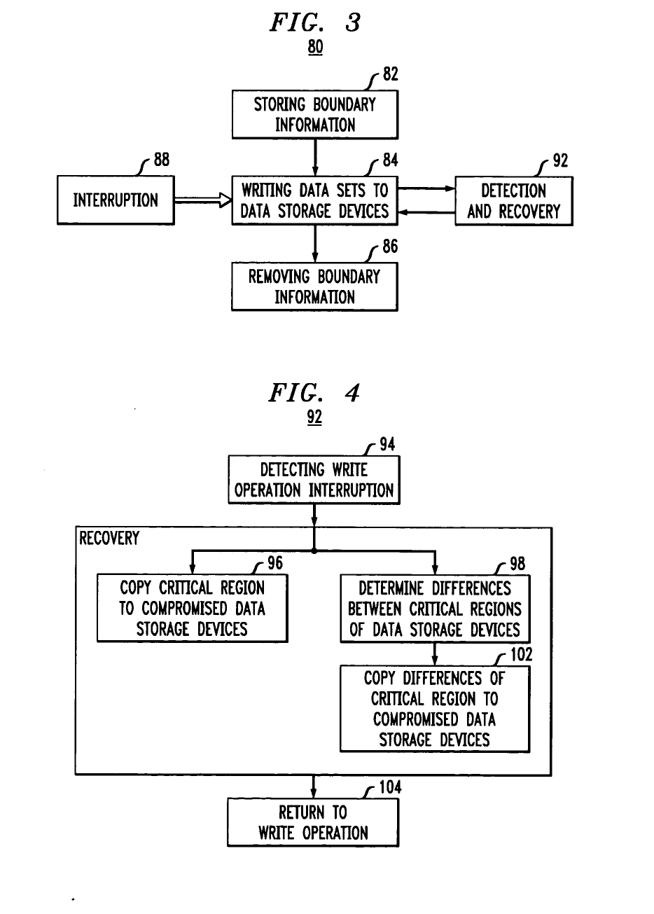

Referring now to FIG. 3, with continuing reference to FIG. 2, shown is a block diagram of a method 80 for writing to the data storage system of FIG. 2 according to embodiments of the invention. The method 80 will be described along with the operation of the data storage system 30. As part of a redundant data storage system, the data storage apparatus 32, via the data storage device controller 34, stores data received thereby to each of the data storage devices 42, 44, 46. Accordingly, if one of the data storage devices subsequently becomes unavailable, such as due to a drive malfunction, data corruption or other condition of unavailability, data can be accessed from one of the other data storage devices that is functioning properly.

The method 80 includes a step 82 of storing boundary information, e.g., to one or more of the data storage devices and/or to the data storage apparatus 32. According to embodiments of the invention, a portion of some or all of the data storage devices, a portion of the data storage apparatus 32 and/or any other appropriate location is reserved for the storage of boundary information. For example, a boundary information location or region on or within some or all of the data storage devices is reserved for the storage of boundary information. Alternatively, a boundary information location or region can be reserved within the data storage apparatus 32 or, alternatively, an external location coupled to one or both of the data storage apparatus 32 and the data storage devices 42, 44, 46. As discussed hereinabove, boundary information can indicate what region of the data storage device to which a particular set or sets of data are to be written, the start location and the end location of the region of the data storage device to which data is to be being written, the start location and a length of the region of the data storage device to which data is to be written, and/or other appropriate information about the data sets to be written to the data storage devices 42, 44, 46.

For example, if N sets of data are received by the data storage apparatus 32 for storage to each of the data storage devices 42, 44, 46, the data storage device controller 34 (or other appropriate component, e.g., within the data storage apparatus 32) reserves a boundary information region or location for the storage of boundary information relating to the storage of the N sets of data to the respective data storage device and/or to all of the data storage devices. For example, the data storage device controller 34 reserves a first boundary information region 51 in the first data storage device 42 for the storage of boundary information relating to the storage of the N sets of data to the first data storage device 42. Alternatively, the data storage device controller 34 reserves the boundary information region 36 therein and/or the boundary information region 38 within the data storage apparatus 32 for the storage of boundary information relating to the storage of the N sets of data to the first data storage device 42. Such boundary information can include information indicating that a first set of data (DATA 1) is to be stored in a first location 52 of the first data storage device 42, a second set of data (DATA 2) is to be stored in a second location 54 of the first data storage device 42, a third set of data (DATA 3) is to be stored in a third location 56 of the first data storage device 42, and an Nth set of data (DATA N) is to be stored in an Nth location 58 of the first data storage device 42.

Also, because the N sets of data also are to be written to the second data storage device 44 and the third data storage device 46, the data storage device controller 34 (or other appropriate component within the data storage apparatus 32) can reserve a second boundary information region or location 61 in the second data storage device 44 and a third boundary information region or location 71 in the third data storage device 46. Similar to the boundary information stored in the first data storage device 42, the boundary information stored in the second boundary information region 61 includes information indicating that the first set of data (DATA 1) is to be stored in a first location 62 of the second data storage device 44, the second set of data (DATA 2) is to be stored in a second location 64 of the second data storage device 44, the third set of data (DATA 3) is to be stored in a third location 66 of the second data storage device 44, and the Nth set of data (DATA N) is to be stored in the Nth location 68 of the second data storage device 44. Similarly, the boundary information stored in the third boundary information region 71 includes information indicating that the first set of data (DATA 1) is to be stored in a first location 72 of the third data storage device 46, the second set of data (DATA 2) is to be stored in a second location 74 of the third data storage device 46, the third set of data (DATA 3) is to be stored in a third location 76 of the third data storage device 46, and the Nth set of data (DATA N) is to be stored in the Nth location 78 of the third data storage device 46.

The method 80 also includes a step 84 of writing one or more data sets to the data storage devices. Once the boundary information has been written to the appropriate boundary information location, e.g., within and/or external to one or more of the data storage devices, the one or more data sets referred to by the boundary information are written to the data storage devices. For example, within the first data storage device 42, once the appropriate boundary information has been written, e.g., to the first boundary information location 51, the first data set (DATA 1) is written to the first location 52, the second data set (DATA 2) is written to the second location 54, the third data set (DATA 3) is written to the third location 56, and the Nth data set (DATA N) is written to the Nth location 58.

Similarly, in the second data storage device 44, once appropriate boundary information has been written, e.g., to the second boundary information location 61, the first data set (DATA 1) is written to the first location 62, the second data set (DATA 2) is written to the second location 64, the third data set (DATA 3) is written to the third location 66, and the Nth data set (DATA N) is written to the Nth location 68. In the third data storage device 46, once appropriate boundary information has been written, e.g., to the third boundary information location 71, the first data set (DATA 1) is written to the first location 72, the second data set (DATA 2) is written to the second location 74, the third data set (DATA 3) is written to the third location 76, and the Nth data set (DATA N) is written to the Nth location 78.

The method 80 also includes a step 86 of removing or deleting the stored boundary information. Once the step 84 of writing one or more data sets to all data storage devices has been completed, the boundary information relating to that data being written to the data storage devices can be removed or deleted from the appropriate boundary information locations or regions. Also, if boundary information relating to the storage of the N sets of data to one or more of the data storage devices 42, 44, 46 was written to the boundary information location 36 within the data storage device controller 34 and/or the boundary information location 38 within the data storage approximately 32, such boundary information can be removed therefrom upon the completion of the writing of the data sets to the appropriate data storage devices.

The method 80 also can include a detection and recovery step 92. If an interruption (shown generally as 88), such as a write operation interruption, occurs to the data storage system 30 during the data writing step 84, the method 80 can detect the write interruption and take the necessary steps to recover from the write interruption. According to embodiments of the invention, the recovery from the write operation interruption makes use of the boundary information, therefore improving the recovery process compared to conventional techniques, e.g., by repairing the effects of the write operation interruption more quickly and efficiently than conventional techniques.

Referring now to FIG. 4, with continuing reference to FIG. 3, shown is block diagram of the detection and recovery step 92 of FIG. 2 according to embodiments of the invention. The detection and recovery step 92 includes a step 94 of detecting the write interruption. The detection step 94 can detect a write operation interruption in any suitable manner, such as the manner in which the detection of a write operation interruption is performed in conventional data storage method and systems.

Once the write operation interruption has been detected, the detection and recovery step 92 can use the boundary information to support a relatively efficient recovery from the interrupted write operation. For example, in one embodiment, recovery involves a step 96 of copying the critical data region to the comprised data storage devices. As discussed hereinabove, the critical region is the region of the data storage device being written to during the write interruption. The boundary information defines or otherwise identifies the critical region on each appropriate data storage device that was the recipient of the write operation interruption. According to embodiments of the invention, only the critical region or regions are considered for recovery and correction. That is, areas of the data storage device outside of or other than the critical region do not have to be corrected (i.e., copied or rewritten), and therefore remain the same on all data storage devices.

Once the critical region has been identified using the boundary information, the copying step 96 copies the critical region data from a source data storage device, i.e., a data storage whose critical region was not compromised by the write operation interruption, to the critical region of each of the target data storage devices, i.e., the data storage devices whose critical region was or may have been compromised by the write operation interruption. By correcting or rewriting only the critical region of each target device, as opposed to conventional techniques that correct or rewrite all data regions of the compromised (target) devices, the recovery process according to embodiments of the invention is much more efficient, e.g., less time consuming and process intensive, than conventional correction techniques.

According to another embodiment of the invention, the detection and recovery step 92 can perform an alternative recovery process, which involves a step 98 of searching for and determining the differences between the critical regions of all the data storage devices, i.e., the differences between the critical region of the source data storage device(s) and the critical region of the target data storage devices. Again, according to embodiments of the invention, the boundary information is used for the identification of the critical regions. This identification of the differences between just the critical regions of the data storage devices compares with some conventional recovery techniques, which determine the differences between all data storage regions of all the data storage devices. According to embodiments of the invention, focusing only on the critical regions of the data storage devices, once the differences between those critical regions have been determined, the detection and recovery step 92 performs a step 102 of copying from the source data storage device to the target data storage devices only the data that was different between the critical region of the source data storage device and the critical region of the target data storage devices.

Upon completion of the recovery, the detection and recovery step 92 performs a step 104 of returning to the step 84 of writing one or more data sets to the data storage devices. The method 80 then continues as discussed hereinabove.

It will be apparent to those skilled in the art that many changes and substitutions can be made to the embodiments of the invention herein described without departing from the spirit and scope of the invention as defined by the appended claims and their full scope of equivalents.

1. A method for writing to a data storage system including a first data storage device and at least one second data storage device, comprising the steps of:
storing boundary information for a write operation of a first set of data to the first data storage device and to the second data storage device;
writing the first set of data to the first data storage device and to the second data storage device; and
removing, upon the completion of the write operation of the first set of data to the first data storage device and the second data storage device, the stored boundary information for the write operation of the first set of data to the first data storage device and to the second data storage device.

2. The method as recited in claim 1, wherein the boundary information defines a critical region on at least one data storage device, wherein the critical region is the region of the data storage device to which the first set of data is to be written.

3. The method as recited in claim 1, further comprising the steps of:
detecting an interruption occurring during the step of writing the first set of data to a first region of the at least one second data storage device; and
recovering from the interruption based on the boundary information for the write operation of the first set of data.

4. The method as recited in claim 3, wherein the recovering step includes copying at least a portion of data from a corresponding first region of the first device to the first region of the at least one second data storage device.

5. The method as recited in claim 3, wherein the recovering step includes determining the differences between the first region of the first data storage device and a corresponding first critical region of the at least one second data storage device, and copying a portion of data from the first region of the first data storage device to the first region of the at least one second data storage device based on the differences.

6. The method as recited in claim 3, wherein the storing step includes storing the boundary information to a boundary information location external to at least one of the first data storage device and the second data storage.

7. The method as recited in claim 1, wherein the boundary information includes at least one of a start location and a length of the data set, and a start address and an end address of the data set.

8. An apparatus for writing to a data storage system including a first data storage device and at least one second data storage device, comprising:
a data storage controller coupled to the first data storage device and the at least one second data storage device,
wherein the data storage controller is configured to store boundary information for a write operation of a first set of data to the first data storage device and to the second data storage device,
wherein the data storage controller is configured to write the first set of data to the first data storage device and to the second data storage device, and
wherein the data storage controller is configured to remove, upon the completion of the write operation of the first set of data to the first data storage device and the second data storage device, the stored boundary information for the write operation of the first set of data to the first data storage device and to the second data storage device.

9. The apparatus as recited in claim 8, wherein the boundary information defines a critical region on at least one data storage device, wherein the critical region is the region of the data storage device to which the first set of data is to be written.

10. The apparatus as recited in claim 8, wherein the data storage controller is configured to detect an interruption occurring during the writing of the first set of data to a first region of the at least one second data storage device, and wherein the data storage controller is configured to recover from the interruption based on the boundary information for the write operation of the first set of data.

11. The apparatus as recited in claim 10, wherein the controller is configured to copy at least a portion of data from a corresponding first region of the first device to the first region of the at least one second data storage device based on the boundary information for the write operation of the first set of data.

12. The apparatus as recited in claim 10, wherein the controller is configured to determine the differences between a corresponding first region of the first data storage device and the first region of the at least one second data storage device based on the boundary information for the write operation of the first set of data, and configured to copy a portion of data from the first region of the first data storage device to the first region of the at least one second data storage device based on the differences.

13. The apparatus as recited in claim 10, wherein the controller is configured to write the boundary information to at least one of the first data storage device and the second data storage.

14. The apparatus as recited in claim 8, wherein the boundary information includes at least one of a start location and a length of the data set, and a start address and an end address of the data set.

15. A data storage system for writing data thereto, comprising:
a first data storage device;
at least one second data storage device; and
a data storage controller coupled to the first data storage device and the at least one second data storage device,
wherein the data storage controller is configured to store boundary information for a write operation of a first set of data to the first data storage device and to the second data storage device,
wherein the data storage controller is configured to write the first set of data to the first data storage device and to the second data storage device, and
wherein the data storage controller is configured to remove, upon the completion of the write operation of the first set of data to the first data storage device and the second data storage device, the stored boundary information for the write operation of the first set of data to the first data storage device and to the second data storage device.

16. The system as recited in claim 15, wherein the data storage controller is configured to detect an interruption occurring during the writing the first set of data to a first region of the at least one second data storage device, and wherein the data storage controller is configured to recover from the interruption based on the boundary information for the write operation of the first set of data.

17. The system as recited in claim 15, wherein the controller is configured to copy at least a portion of data from a corresponding first region of the first device to the first region of the at least one second data storage device based on the boundary information for the write operation of the first set of data.

18. The system as recited in claim 15, wherein the controller is configured to determine the differences between a corresponding first region of the first data storage device and the first region of the at least one second data storage device based on the boundary information for the write operation of the first set of data, and configured to copy a portion of data from the first region of the first data storage device to the first region of the at least one second data storage device based on the differences.

19. The system as recited in claim 15, wherein the controller is configured to write the boundary information to at least one of the first data storage device and the second data storage.

20. A computer readable medium storing instructions that carry out a method for writing to a data storage system including a first data storage device and at least one second data storage device, the computer readable medium comprising:
instructions for storing boundary information for a write operation of a first set of data to the first data storage device and to the second data storage device;
instructions for writing the first set of data to the first data storage device and to the second data storage device; and
instructions for removing, upon the completion of the write operation of the first set of data to the first data storage device and the second data storage device, the stored boundary information for the write operation of the first set of data to the first data storage device and to the second data storage device.

21. The computer readable medium as recited in claim 20, wherein the computer readable medium further comprises:
instructions for detecting an interruption occurring during the step of writing the first set of data to a first region of the at least one second data storage device, and
instructions for recovering from the interruption based on the boundary information for the write operation of the first set of data.

22. The computer readable medium as recited in claim 21, wherein the instructions for recovering includes instructions for copying at least a portion of data from a corresponding first region of the first device to the first region of the at least one second data storage device.

23. The computer readable medium as recited in claim 21, wherein the instructions for recovering includes instructions for determining the differences between a corresponding first region of the first data storage device and the first region of the at least one second data storage device, and instructions for copying a portion of data from the first region of the first data storage device to the first region of the at least one second data storage device based on the differences.

24. The computer readable medium as recited in claim 20, wherein the instructions for removing removes the boundary information from the first data storage device and the second data storage upon the completion of the recovering step.
